(19) United States
(12) Patent Application Publication
(10) Pub. No.: US 2013/0013697 A1
(43) Pub. Date: Jan. 10, 2013

(54) GROUP GENERATION DEVICE

(76) Inventor: Yasuhiro Tsuchida, Osaka (JP)

(21) Appl. No.: 13/636,222

(22) PCT Filed: Jan. 18, 2012
(86) PCT No.: PCT/JP2012/000278

§ 371 Date: Sep. 20, 2012

(30) Foreign Application Priority Data
Feb. 14, 2011 (JP) 2011-028201

(51) Int. Cl. G06F 15/16

(52) U.S. Cl. 709/204

(57) ABSTRACT

A generation section 102 generates a group of which an information communication terminal having transmitted a group generation request is representative. A region control section 103 sets a group region of the generated group based on a state at a position at which the representative information communication terminal is located. A determination section 104 determines whether or not an information communication terminal having transmitted a group participation request is within the group region, and permits, when the information communication terminal is determined to be within the group region, the information communication terminal to participate in the group.

### TECHNICAL FIELD

The present invention relates to group generation devices for generating groups to be each formed by a plurality of information terminals located at predetermined positions.

### BACKGROUND ART

In recent years, the SNS (Social Networking Service) that is a service for allowing, for example, persons having a relationship in the real world or persons sharing a common interest in a world of the Internet to build a network and perform information exchange and the like, has been widespread.

In the SNS, a user is allowed to generate a community that is a group for, for example, exchanging information on a specific topic. A user who has generated a community is able to invite another user to the community, while a user who is interested in the community is allowed to make a request for participating in the community.

However, procedures for generation of a community, invitation thereto, and participation therein are complicated. An exemplary case will be described in which plural company staff members who have gathered for a meeting in a company generate a community in order to continue a discussion after the meeting. In this case, a staff member in charge of generating a community operates to display an SNS site, logs in, and inputs information necessary for generating a community, to generate a community. Thereafter, the staff member sends an invitation to other staff members by e-mail, or asks other staff members to retrieve the generated community. The other staff members log into the SNS site, input necessary information, and issue requests for participation, in order to participate in the generated community. The staff member in charge of generating the community grants permission for the requests from all the other staff members. These procedures are quite complicated as procedures for an informal request for generating a community and continuing a discussion. Therefore, a community is rarely generated for this purpose.

As a conventional technique for solving this problem, a technique is known in which positional information is utilized, to retrieve a community by using, for example, information on shops located at that position, as a keyword. In the conventional technique, for example, when a community is generated in a meeting room, a community which is assigned a keyword of “meeting” can be generated without causing a user to make an input. Further, when community participants retrieve, in the meeting room, a community in which the community participants are to participate, the community participants are allowed to retrieve communities containing the keyword of “meeting” without inputting the keyword of “meeting” (for example, see Patent Literature 1).

Further, a technique is known in which, by utilizing near field communication means such as infrared communication, invitation to a community and approval of participation in the community are performed merely by bringing an information terminal of a community generator and information terminals of persons that desire the participation close to each other (see, for example, Patent Literature 2).

### CITATION LIST

### Patent Literature

Patent Literature 1: Japanese Laid-Open Patent Publication No. 2007-306409

Patent Literature 2: Japanese Patent No. 430322

### SUMMARY OF THE INVENTION

### Problems to be Solved by the Invention

However, in the conventional technique as described above, in a case where many users are in a narrow space such as an event hall or a restaurant, and plural persons who desire to generate communities are in this space, a problem arises that overlapping of communities occurs.

In a case where plural users start generation of and invitation to groups (such as communities) by using the same keyword in the same place, a group may be unintentionally generated by plural groups being combined with each other. Further, also in a case where plural groups are generated, a community participant needs to select a group in which the community participant is to participate, from among the plural groups. Therefore, a community generator needs to assign, to the community, a keyword different from that for other communities, and perform a procedure for inviting the community participants to the community generated by the community generator.

Therefore, an object of the preset invention is to make available a group generation device capable of optimally setting a region within which participation in a group is accepted, based on a state at a position at which the group is to be generated.

### Solution to the Problems

The present invention is directed to a group generation device for generating a group to be formed by a plurality of information communication terminals located at predetermined positions. In order to attain the objects described above, the group generation device of the present invention includes: a reception section configured to receive a group generation request transmitted from an information communication terminal which generates a group, and a group participation request transmitted from an information communication terminal which participates in a group; a generation section configured to generate a group of which a master information communication terminal having transmitted the group generation request is representative; a region control section configured to check a state at a position at which the master information communication terminal is located, by utilizing positional information of the master information communication terminal, and set, based on the state, a group region of the group generated by the generation section; and a determination section configured to determine, by utilizing positional information of a subordinate information communication terminal having transmitted the group participation request, whether or not the subordinate information communication terminal is within the group region. In the group generation device, the determination section permits the subordinate information communication terminal which is determined to be within the group region to participate in the group.

It is preferable that the region control section checks a congestion state at a position at which the master information communication terminal is located, based on the number of the subordinate information communication terminals located within a predetermined range from the position of the master information communication terminal, and when the predetermined range is congested, the group region is reduced. Further, preferably, the region control section checks the congestion state by using information about groups previously generated in the vicinity of the position at which the master information communication terminal is located.

Further, the region control section may obtain the positional information of the master information communication terminal and error information for a position indicated by the positional information, and set the group region by using the positional information and the error information having been obtained, and the region control section may further obtain the positional information of the subordinate information communication terminal located within a predetermined range from the position of the master information communication terminal, and error information for a position indicated by the positional information, and set the group region by using the positional information and the error information having been obtained.

Furthermore, it is favorable that the region control section checks whether or not the group region for the master information communication terminal overlaps another group region generated by another master information communication terminal which is located within a predetermined range from the position of the master information communication terminal, and sets a region which does not overlap the other group region, as the group region generated by the generation section. In this case, the region control section may check whether or not the group region for the master information communication terminal overlaps another group region generated by another master information communication terminal which is located within a predetermined range from the position of the master information communication terminal, and request, when the group region generated by the generation section overlaps the other group region, the other master information communication terminal to change the other group region.

The process steps performed by the group generation device described above, can be implemented as a group generation method for performing a series of process steps. This method is provided in a form of a program for causing a computer to execute the series of process steps. The program may be loaded into a computer by being stored in a computer-readable storage medium. Further, a part or the entirety of functional blocks of the transmission/reception apparatus described above may be implemented as an LSI which is an integrated circuit.

### Advantageous Effects of the Invention

The group generation device of the present invention as described above sets, based on a state at a position at which a group is generated, a region within which a request for participation in the group is accepted. Therefore, even if the vicinity of the information communication terminal is heavily congested, subjects that are allowed to participate in a group can be appropriately controlled. Thus, a plurality of users can generate a desired group (community) without performing complicated procedures.

### BRIEF DESCRIPTION OF THE DRAWINGS

FIG. 1 is a block diagram illustrating a configuration of an information communication terminal 1 having incorporated therein a group generation device 10 according to one embodiment of the present invention.

FIG. 2A illustrates an example of group information stored in a group information storage section 11.

FIG. 2B illustrates an example of region information stored in the group information storage section 11.

FIG. 3A illustrates an example of user information stored in a user information storage section 12.

FIG. 3B illustrates an example of group user information stored in the user information storage section 12.

FIG. 4 is a flow chart showing procedures of a group generation process and a group participation process executed by the information communication terminal 1 according to one embodiment of the present invention.

FIG. 5 illustrates examples of display screens 16a1 to 16a4 displayed on a display section 16a of a group generation terminal 1a.

FIG. 6 illustrates examples of display screens 16b1 to 16b4 displayed on a display section 16b of a group participation terminal 1b.

FIG. 7 is a flow chart showing a procedure of a region setting process in the group generation process.

FIG. 8 illustrates a positional relationship among information communication terminals 1a to 1d.

FIG. 9 illustrates examples of positional information 3a to 3d having been obtained by positional information obtaining sections 13 of the information communication terminals 1a to 1d.

FIG. 10 illustrates an exemplary region set by a region control section 103a.

FIG. 11 illustrates an exemplary region set by the region control section 103a.

FIG. 12A shows a sequence for the group generation process and the group participation process executed among a plurality of the information communication terminals 1.

FIG. 12B shows a sequence for the group generation process and the group participation process executed among the plurality of the information communication terminals 1.

FIG. 12C shows a sequence for the group generation process and the group participation process executed among the plurality of the information communication terminals 1.

FIG. 13 illustrates an example of a display screen 16a5 displayed on the display section 16a.

### DESCRIPTION OF EMBODIMENTS

Hereinafter, embodiments of the present invention will be described with reference to the drawings.

In the present embodiment, an exemplary case will be described in which a group generation device according to the present invention is mounted to an information communication terminal, and generates a group (community) for performing, for example, information exchange by communication being performed among a plurality of information communication terminals.

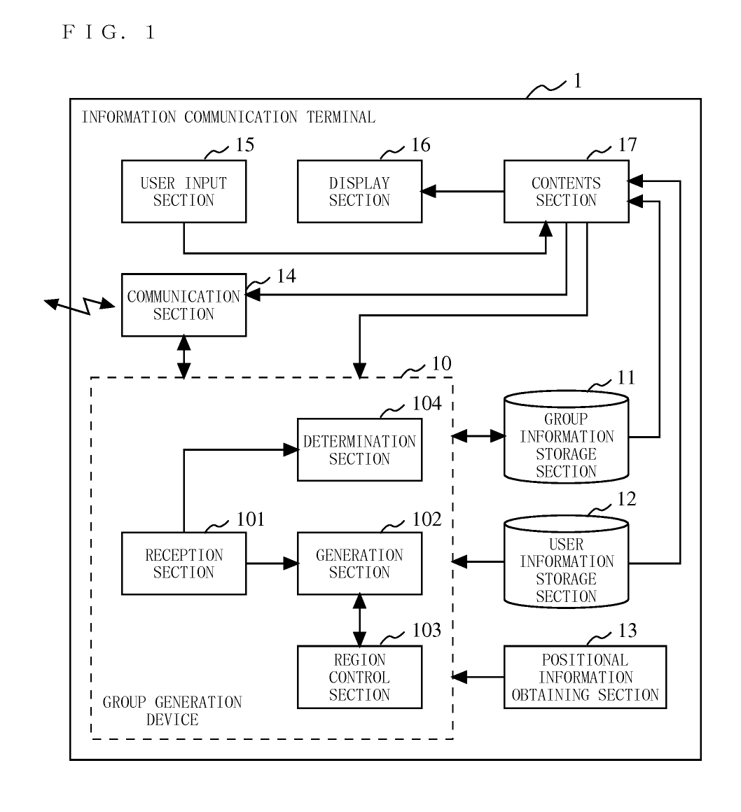

FIG. 1 illustrates a configuration of an information communication terminal 1 having incorporated therein a group generation device 10 according to one embodiment of the present invention. The information communication terminal 1 represents portable information communication terminals, such as mobile telephones, smartphones, portable music players, hand-held game devices, and PDAs (personal digital assistants), each of which has mounted therein a display and user operation input means (such as a keyboard and a touch panel), and has a communication function.

In FIG. 1, the information communication terminal 1 includes the group generation device 10 which is a characteristic feature of the present invention, a group information storage section 11, a user information storage section 12, a positional information obtaining section 13, a communication section 14, a user input section 15, a display section 16, and a contents section 17. The group generation device 10 includes a reception section 101, a generation section 102, a region control section 103, and a determination section 104.

### 1. OUTLINE OF COMPONENTS OF INFORMATION COMMUNICATION TERMINAL

Firstly, an outline of components of the information communication terminal 1 will be described.

The communication section 14 performs data transmission to and data reception from other information communication terminals 1 in compliance with a communication protocol such as TCP/IP (Transmission Control Protocol/Internet Protocol), by using communication means such as a wireless LAN (local area network), and the like.

The user input section 15 receives an operation (hereinafter, referred to a user operation) performed by a user on the information communication terminal 1, and outputs the received operation contents to the contents section 17 as a user operation event. Examples of the user operation include a keyboard input, a touch panel operation, and pressing of a button.

The contents section 17 executes interactive contents for supporting generation of a group by a user and participation of a user in a group, based on the user operation event outputted by the user input section 15.

The display section 16 displays, on a display device, display information generated by the contents section 17 executing contents. Examples of the display device include a liquid crystal display and an organic EL display.

The positional information obtaining section 13 has a positional information obtaining function using any one of the GPS (global positioning system), a wireless LAN, and a 3G base station network, or a combination thereof, and obtains positional information of the information communication terminal 1. The obtained positional information includes the latitude, the longitude, an error, and the like. The positional information contains an error because an error (about several tens of meters to several hundreds of meters in a room) generated in the GPS which is currently put into a practical use is considered.

The reception section 101 receives, through the contents section 17, a group generation request inputted to the user input section 15 by a user. Further, the reception section 101 receives, through the communication section 14, a positional information obtaining request, a positional information notification, a group search request, a group information notification, a group participation request, and a group participation permission notification. The positional information obtaining request, the group information notification, and the group participation permission notification are information that is received by the information communication terminal 1 that acts as a group generator, from another information communication terminal 1. The positional information notification, the group search request, and the group participation request are information that is received by the information communication terminal 1 that acts as a group participant, from the information communication terminal 1 that acts as a group generator. The respective requests and notifications will be described below.

When the reception section 101 receives a group generation request, the generation section 102 generates a group according to contents of the request, and stores information about the generated group, in the group information storage section 11.

The region control section 103 sets a region (hereinafter, referred to as a group region) within which a request, from another information communication terminal 1, for participating in the group that is generated by the generation section 102 is accepted. Specifically, the region control section 103 obtains a current position of its own terminal from the positional information obtaining section 13, and sets a position, a shape, and a range of the region based on a state at the position of its own terminal. In the description herein, the region is represented by a position, a shape, and a range of an enclosed space on the ground. For example, the region is specified by a position, a shape, and a range as, for example, “an inside of a circle having a radius of 100 m, and having the center thereof at 34.74 degrees latitude and 135.58 degrees longitude”. A specific process performed by the region control section 103 will be described below.

When the reception section 101 receives a group participation request, the determination section 104 determines whether or not another user (another information communication terminal 1) which has transmitted this request is allowed to participate in the group generated by the user (using this information communication terminal 1).

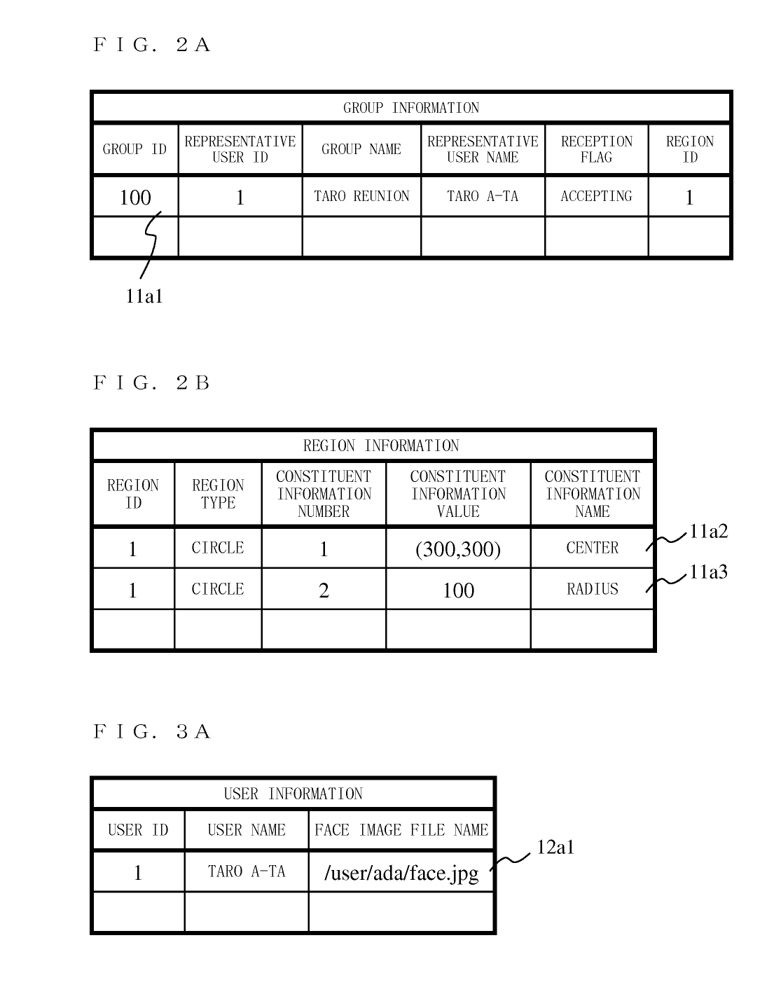

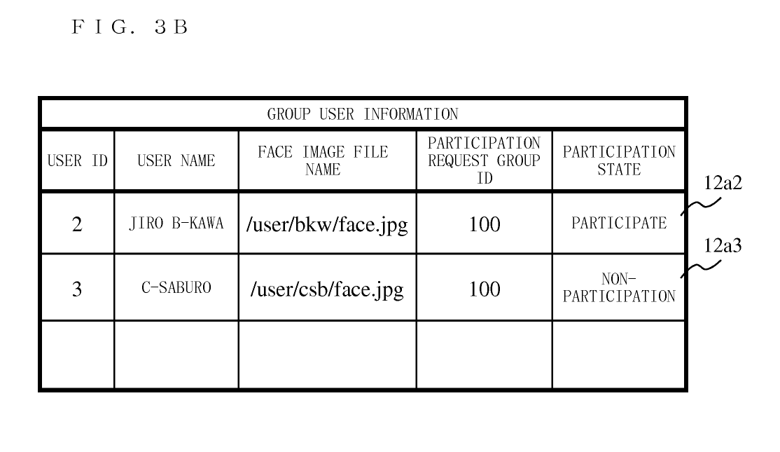

The group information storage section 11 is a memory region allocated in, for example, a RAM (random access memory) of the information communication terminal 1, and stores group information generated by its own information communication terminal 1, group information generated by another information communication terminal 1 which are participants, and region information. FIG. 2A illustrates an example of group information stored in the group information storage section 11. FIG. 2B illustrates an example of region information stored in the group information storage section 11.

The group information shown in FIG. 2A contains a group ID, a representative user ID, a group name, a representative user name, a reception flag, and a region ID. The group ID is an identifier for uniquely identifying a group. The representative user ID is an identifier for uniquely identifying a user that has generated the group. The group name represents a name of the group. The representative user name represents a name of a user that has generated the group. The reception flag indicates whether or not the group is accepting participants. The region ID is an identifier for uniquely identifying a group region within which a request for participation in the group is being accepted.

The region information shown in FIG. 2B contains the region ID, a region type, and constituent information. The region ID is an identifier for uniquely identifying a region. The region type is information for specifying a shape of the region, and represents a type of a shape represented by the constituent information. The region type represents, for example, a “circle”, a “rectangular shape”, or “any polygonal shape”. The constituent information contains a constituent information number, a constituent information value, and a constituent information name, and is written as a parameter necessary for representing a shape indicated by the region type. For example, when the region type represents a “circle”, a circular region is represented by the constituent information representing “the center” of a circle, and the constituent information “representing a radius” of the circle.

The user information storage section 12 is a memory region allocated in, for example, the RAM of the information communication terminal 1, and stores user information of an owner of the information communication terminal 1, and group user information of another user that is allowed to participate in the group generated by the user. FIG. 3A illustrates an example of user information stored in the user information storage section 12. FIG. 3B illustrates an example of group user information stored in the user information storage section 12.

The user information shown in FIG. 3A contains a user ID, a user name, and a face image file name. The user ID is an identifier for uniquely identifying a user that owns the terminal. The user name represents a name of the user that owns the terminal. The face image file name is information that specifies a file in which a user's face image is stored.

The group user information shown in FIG. 3B contains a user ID, a user name, a face image file name, a participation request group ID, and a participation state. The user ID, the user name, and the face image file name are as described above. The participation request group ID is an identifier for uniquely identifying a group in which a user participates, or in which a user requests to participate. The participation state indicates whether or not the user is a participant in the group specified by the participation request group ID.

### 2. PROCESS EXECUTED BY INFORMATION COMMUNICATION TERMINAL

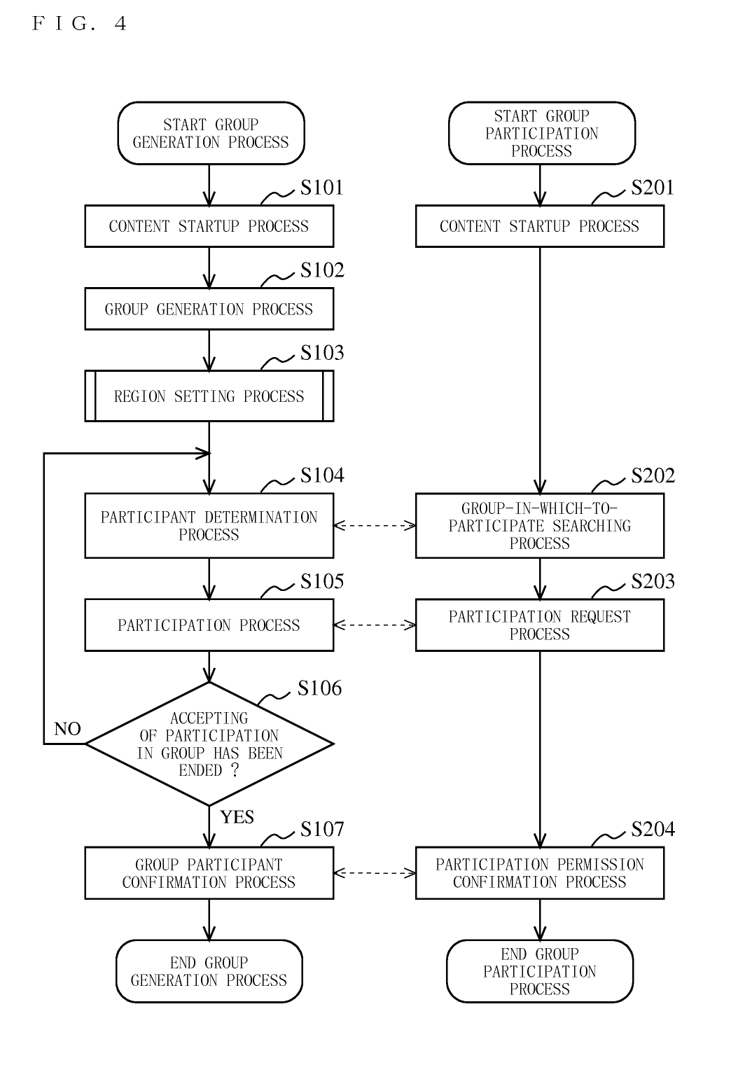

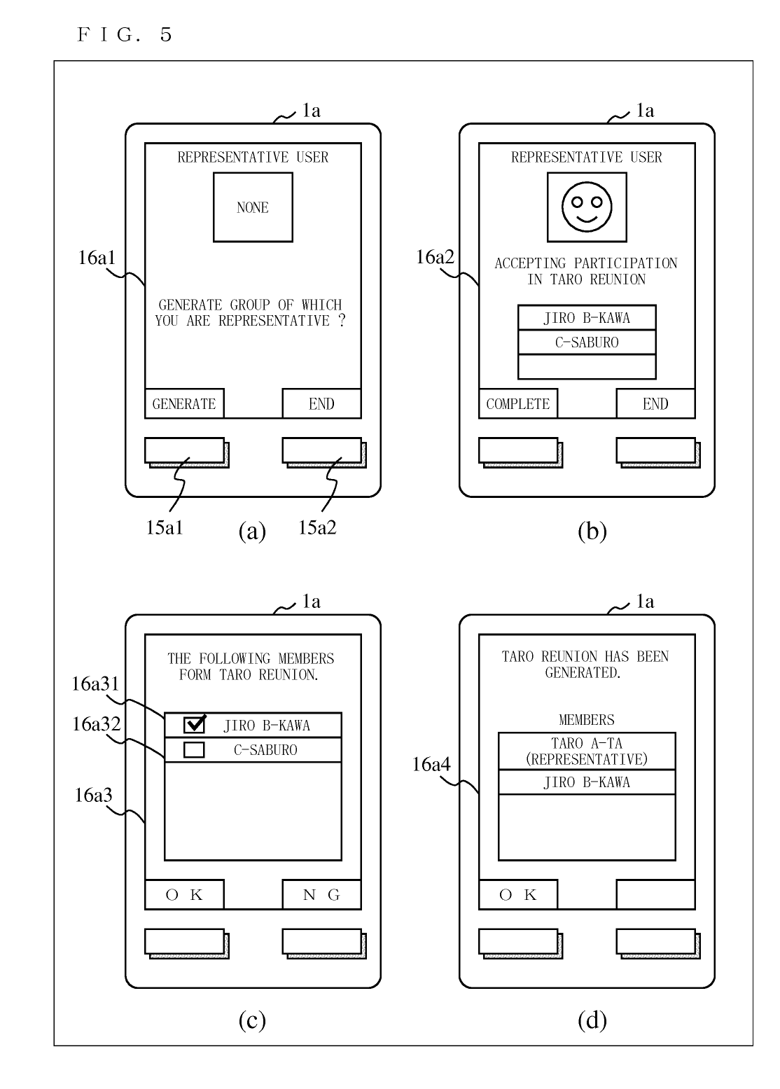

Next, a group generation process and a group participation process executed by the information communication terminal 1 according to one embodiment of the present invention will be described with further reference to FIG. 4 to FIG. 6.

FIG. 4 is a flow chart showing procedures of the group generation process and the group participation process executed by the information communication terminal 1 according to one embodiment of the present invention. In FIG. 4, the group generation process (the left portion in the figure) executed by the master information communication terminal 1 (hereinafter, referred to as a group generation terminal 1a) that generates a group on its own and invites participants, and the group participation process (the right portion in the figure) executed by the subordinate information communication terminal 1 (hereinafter, referred to as a group participation terminal 1b) that attempts to participate in a group having been already generated, are indicated in parallel for easy understanding. In the following description, components of the group generation terminal 1a are denoted by suffixing the reference numeral with “a”, while components of the group participation terminal 1b are denoted by suffixing the reference numeral with “b”, so as to distinguish therebetween.

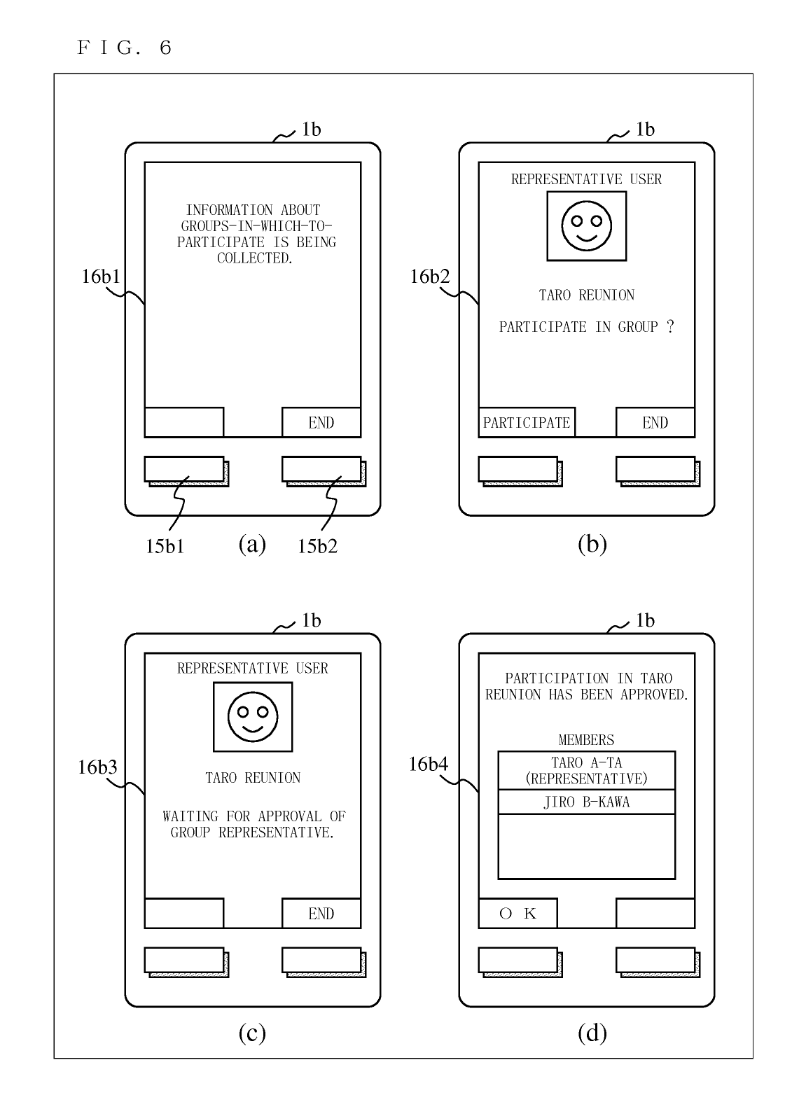

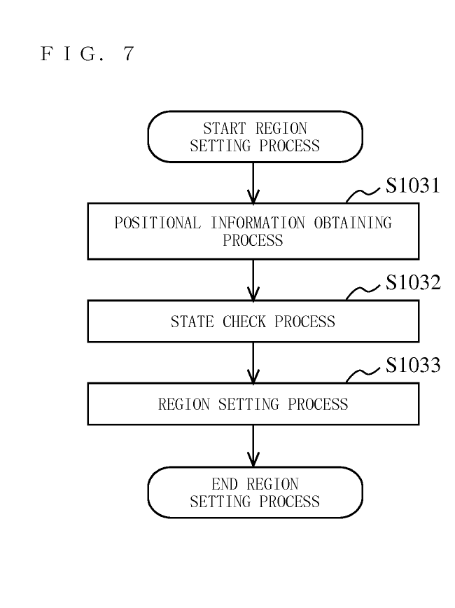

FIG. 5 illustrates examples of display screens 16a1 to 16a4 displayed on a display section 16a of the group generation terminal 1a. FIG. 6 illustrates examples of display screens 16b1 to 16b4 displayed on a display section 16b of the group participation terminal 1b. In FIG. 5 and FIG. 6, the user input section 15 shown in FIG. 1 corresponds to the operation buttons 15a1, 15a2, 15b1, and 15b2, and the operation buttons correspond to guidance contents displayed on the display screens of the display sections 16a and 16b.

In the following description, Mr. Taro A-ta of the user ID “1” generates a group by using the group generation terminal 1a, and Mr. Jiro B-kawa of the user ID “2” participates in the group by using the group participation terminal 1b.

2-1. Group Generation Process

Firstly, a flow of a process performed by the group generation terminal 1a for generating a new group will be described.

The contents section 17a performs startup of a content for generating a group (step S101). Specifically, the user input section 15a receives an operation performed by a user for selecting a group generation content from a list of contents, and notifies the contents section 17a of the operation as a user operation event. The contents section 17a reads the content selected by the user, from a contents storage section which is not shown, and delivers the content to a contents engine. The contents engine starts to execute the delivered content. By this process, an initial screen 16a1 for the group generation content is displayed on the display section 16a (FIG. 5(a)).

The generation section 102a generates a group when receiving a group generation request (step S102). Specifically, when the user operates “generate” on the initial screen for the group generation content (when the operation button 15a1 shown in FIG. 5(a) is pressed), the contents section 17a issues the group generation request to the reception section 101a. The reception section 101a requests, when receiving the group generation request, the generation section 102a to generate a group. The generation section 102a reads the user ID and the user name of the group generation terminal 1a from the user information storage section 12a. Further, the generation section 102a generates a unique group ID by utilizing information, such as a MAC address, unique to the information communication terminal 1. For example, “MAC address+current time” may be used as the group ID. Further, the generation section 102a displays a user interface for group name input, on the display section 16a, through the contents section 17a, and receives an input of the group name from the user. The generation section 102a generates group information according to the user ID, the user name, the group ID, and the inputted group name, and stores the group information in the group information storage section 11a. The reception flag is set as “accepting” when participants in the group are being accepted, while the reception flag is set as “accepting has been ended” when the accepting of participants in the group has been ended. Further, “0” is set as the region ID until the region is set, and the region ID is settled when the region is set. FIG. 2A illustrates group information 11a1 for which the group name is “Taro Reunion” and the group ID is “100”.

When the group has been generated by the generation section 102a, the region control section 103a sets a group region within which a request for participation in the group is accepted (step S103). A process for setting the group region will be described below in detail. FIG. 2B illustrates region information 11a2 and region information 11a3 that are generated by the region control section 103a. The region information 11a2 and the region information 11a3 having been generated are each assigned a region ID for uniquely identifying a group region (“1” is set in the example of FIG. 2B), and the same value (“1” in the example of FIG. 2A) as the region ID having been assigned is set as the region ID of the group information 11al.

When the group region is set by the region control section 103a, the determination section 104a determines whether or not other terminals in the vicinity of its own terminal may participate in the group (step S104). Specifically, the reception section 101a receives a group search request from the group participation terminal 1b through the communication section 14a. The determination section 104a extracts the positional information of the group participation terminal 1b from the group search request received by the reception section 101a, and obtains the region information of the group from the group information storage section 11a. Specifically, the determination section 104a extracts the region ID of the group information in which the reception flag represents “accepting”, from the group information storage section 11a, and extracts the region information having the region ID. In FIG. 2A, the determination section 104a reads the region ID indicating “1” from the group information 11a1 in which the reception flag represents “accepting”, and extracts the region information 11a2 and the region information 11a3 which have the region ID indicating “1”. The determination section 104a determines whether or not the extracted positional information of the group participation terminal 1b represents a position within the group region identified by the region information. The specific process of this determination will be described below. The determination section 104a transmits the group information notification which represents a determination result, to the group participation terminal 1b that has transmitted the group participation request, through the communication section 14a.

The generation section 102a performs a process of accepting the participation in the group, which is requested by the group participation terminal 1b having been determined to be able to participate in the group (step S105). Specifically, the reception section 101a accepts the group participation request from the group participation terminal 1b through the communication section 14a. The group participation request contains the user ID, the user name, the face image file, and the positional information of the participation requesting member. The generation section 102a writes the information into the group user information in the user information storage section 12a according to the group participation request. As the face image file name, the face image file contained in the group participation request is written into a file system of the group generation terminal 1a, and a name of the file having been written is designated. Further, the participation state is temporarily set as “non-participation”. In FIG. 3B, the group user information 12a2 is generated based on the group participation request received from the group participation terminal 1b of the user, “Jiro B-kawa”, and the group user information 12a3 is generated based on the participation request received from the group participation terminal 1d of the user, “C-saburo”. Further, the contents section 17a reads, from the user information storage section 12a, the group user information of groups for which participation therein is being accepted, and the display screen 16a2 is displayed on the display section 16a (FIG. 5(b)). Thus, the user is allowed to confirm the state of participation in the group.

The process steps of step S104 to step S105 are repeatedly performed until the user of the group generation terminal 1a issues an instruction for ending the accepting of the participation in the group (step S106). For example, when the user operates “completion” on the display screen 16a2 shown in FIG. 5(b) (presses the operation buttons 15a1), the accepting of the participation in the group is completed.

When the accepting of the participation in the group has been completed, the generation section 102a settles the participant users, and ends the group generation process (step S107). Specifically, the generation section 102a issues a request for confirmation to the contents section 17a. In response thereto, the contents section 17a reads, from the user information storage section 12a, the group user information having, as the participation request group ID, the group ID of the group for which the accepting of the participation therein has been completed. The contents section 17a displays, on the display section 16a, a display screen 16a3 for checking permission of users' participation based on the group user information having been read, and receives an input from the user (FIG. 5(c)). In the present embodiment, the group ID of the group being generated is “100” (FIG. 2A). Therefore, the display screen 16a3 for checking permission of the users' participation is generated based on the group user information 12a2 and the group user information 12a3 (FIG. 3B) which have the participation request group ID indicating “100”, and is represented as display information 16a31 and display information 16a32 (FIG. 5(c)).

The user checks off only the users who are permitted to participate therein, on the display screen 16a3. Finally, when the user operates “OK” (presses the operation button 15a1 shown in FIG. 5(c)), the permission of the users' participation is settled. When the user participation permission check is as indicated in FIG. 5(c), the user participation permission is selected for the user name, “Jiro B-kawa”, and rejection of user participation is selected for the user name, “C-saburo”. The generation section 102a updates the participation state (FIG. 3B) contained in the group user information of the user information storage section 12a according to the selection for the users. In the present embodiment, the participation state is updated to “participate” for the group user information 12a2. The generation section 102a updates, when receiving, from the contents section 17a, notification that the user participation permission process has been completed, the reception flag of the group information (in the present embodiment, the group information 11a1 of the group ID indicating “100”) of the group being generated, so as to indicate “accepting has been completed”. Finally, the generation section 102a reads, from the user information storage section 12, the group user information (FIG. 3B) having the group ID of the groups having been already generated, and notifies the users for which the participation state represents “participate” that the participation is permitted. Further, the generation section 102a indicates to the user a display screen 16a4 indicating information about the group having been already generated (FIG. 5(d)).

When the user operates “end” on the display screen 16a1 or 16a2 shown in FIG. 5 (presses the operation button 15a2 shown in FIG. 5(a) or (b)), the process steps subsequent thereto are not performed, and the group generation process is ended.

2-2. Group Participation Process

Next, a flow of a process in which the group participation terminal 1b participates in a new group will be described.

The contents section 17b performs startup of a content for participating in a group (step S201). Specifically, the user input section 15b receives an operation performed by a user for selecting a group participation content from a list of contents, and notifies the contents section 17b of the operation as a user operation event. The contents section 17b reads the content selected by the user, from the contents storage section which is not shown, and delivers the content to the contents engine. The contents engine starts to execute the delivered content. By this process, an initial screen 16b1 of the group participation content is displayed on the display section 16b (FIG. 6(a)).

The contents section 17b attempts to search for a group so as to determine whether or not a group in which its own terminal can participate is located in the vicinity of its own terminal (step S202). Specifically, the contents section 17b performs broadcast transmission of a group search request, to terminals, including the group generation terminal 1a, which are located in the vicinity, through the communication section 14b. The contents section 17b determines, when receiving a notification of the group information from the group generation terminal 1a as a response to the group search request, that a group in which the own terminal can participate is located in the vicinity of its own terminal The contents section 17b extracts a group name, a representative user name, a face image, and the like which are contained in the group information received from the group generation terminal 1a, and generates a display screen 16b2 (FIG. 6(b)).

Next, the contents section 17b issues a request for participation in the group of which the group information has been received as notification (step S203). Specifically, when the user operates “participate” on the display screen 16b2 (presses the operation button 15b1 shown in FIG. 6(b)), the contents section 17b extracts a user ID, a user name, and a face image file name from the user information storage section 12b. Further, the contents section 17b extracts a face image file designated by the face image file name, from a file system. The contents section 17b generates a group participation request containing the user ID, the user name, the face image file, and the positional information as constituent elements, and transmits the group participation request to the group generation terminal 1a. The group participation terminal 1b displays a display screen 16b3 until the participation is approved by the group generation terminal 1a (FIG. 6(c)).

When the group participation permission notification is received from the group generation terminal 1a, the group participation terminal 1b displays a display screen 16b4 (FIG. 6(d)) with information about other users for which permission of participation in the group has been approved (step S204).

When the user operates “end” on the display screens 16b1 to 16b3 shown in FIG. 6 (presses the operation button 15b2 shown in FIG. 5(a) to (c)), the process steps subsequent thereto are not performed, and the group participation process is ended.

2-3. Region Setting Process

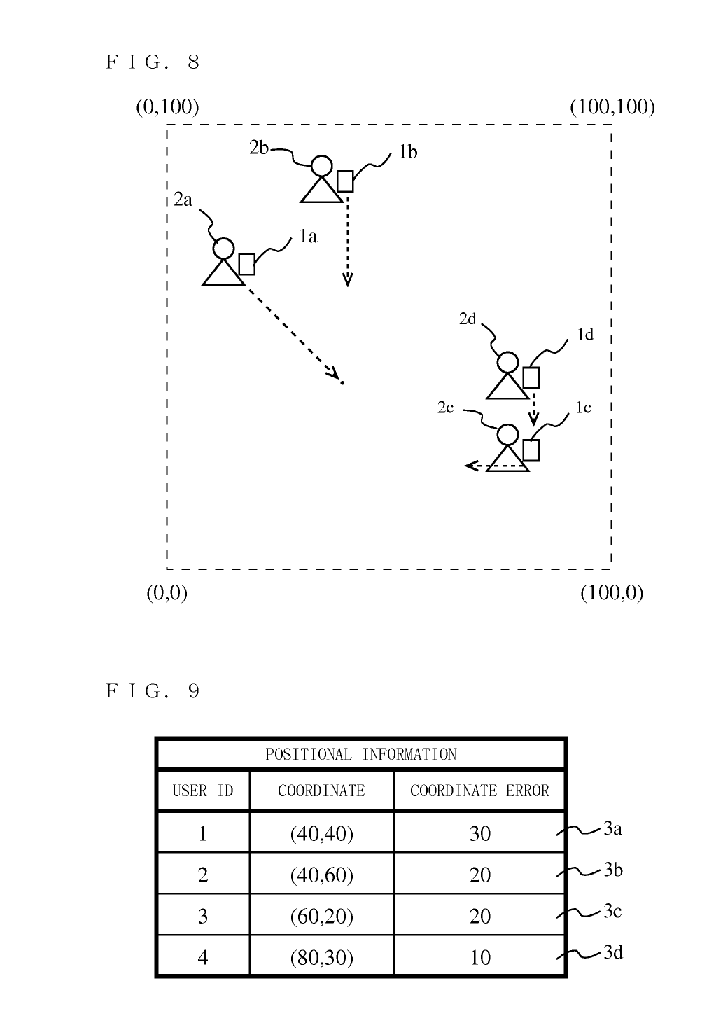

Hereinafter, a flow of a region setting process in the group generation process will be described in detail according to an exemplary case shown in FIG. 7 to FIG. 11.

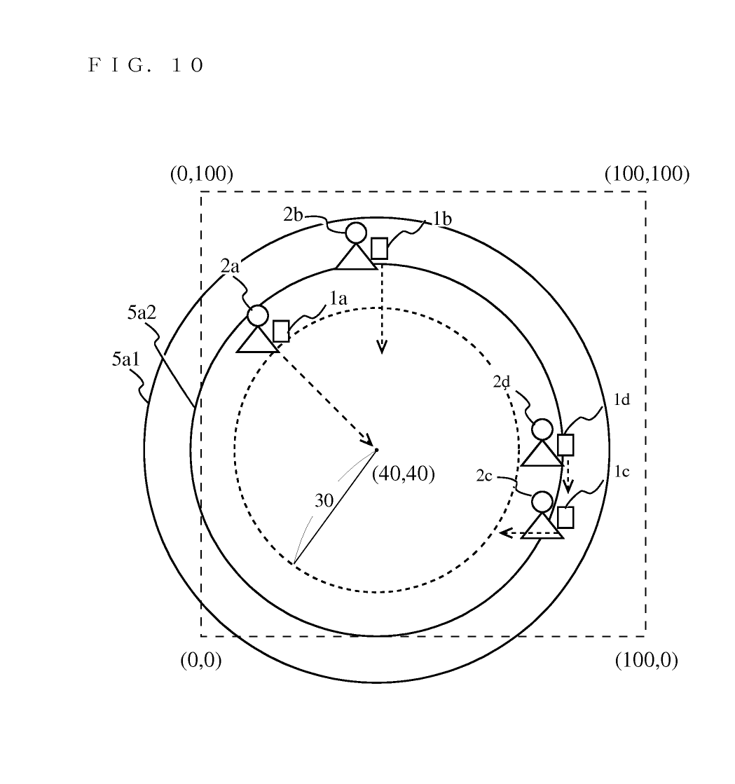

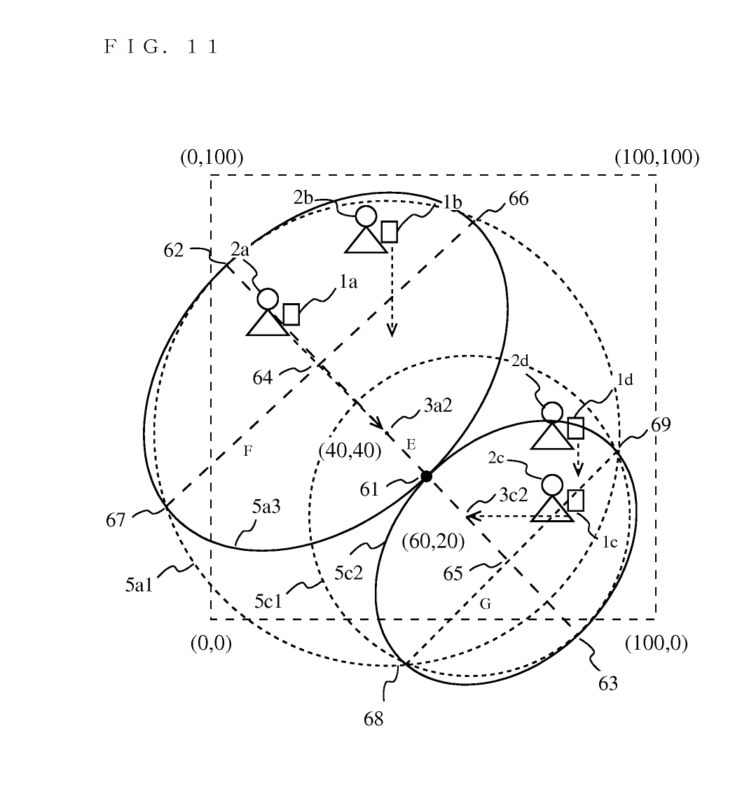

FIG. 7 is a flow chart showing a procedure of the region setting process (step S103 shown in FIG. 4) in the group generation process. FIG. 8 illustrates a positional relationship among a plurality of information communication terminals 1a to 1d referred to in the following description. In FIG. 8, positions of four users 2a to 2d which own the information communication terminals 1a to 1d, respectively, are represented in a coordinate system in which the lower left position is indicated as (0, 0) and the upper right position is indicated as (100, 100). FIG. 9 illustrates examples of positional information 3a to 3d having been obtained by the positional information obtaining sections 13 of the information communication terminals 1a to 1d (the user IDs are “1” to “4”), respectively, which are shown in FIG. 8.

In this exemplary case, it is assumed that the information communication terminals 1a to 1d are actually located at coordinate positions of (20, 60), (40, 80), (80, 20), and (80, 40), respectively. On the other hand, the positional information obtaining sections 13a to 13d of the information communication terminals 1a to 1d obtain coordinate positions of (40, 40), (40, 60), (60, 20), and (80, 30) and coordinate errors of 30, 20, 20, and 10, respectively. The coordinate error represents a parameter that involves a measurement error of the positional information obtaining section 13, and indicates that the information communication terminal 1 is positioned inside a circle in which the coordinate position represents the center and the coordinate error represents the radius. Dashed arrows for which the information communication terminals 1a to 1d shown in FIG. 8 are start points are drawn such that the start points represent actual coordinate positions, and end points represent the coordinate positions obtained by the positional information obtaining sections 13. In the following description, a user 2a issues a group generation request by using the group generation terminal 1a in this positional relationship.

The region control section 103a performs a process of obtaining the positional information of its own terminal and other terminals (step S1031). Specifically, the region control section 103a obtains the positional information of the group generation terminal 1a, from the positional information obtaining section 13a. Next, the region control section 103a performs broadcast transmission of the positional information obtaining request, and obtains the number N of the information communication terminals which are located in the vicinity, and the positional information thereof In the description herein, the information communication terminals which are located in the vicinity are the information communication terminals which are located within a distance of a predetermined value (for example, “100”), and are capable of performing a near field communication. The near field communication is a direct communication using no server, and is, for example, BlueTooth (registered trademark) communication. In the example of FIG. 8, for the group participation terminals 1b to 1d, “the number N of terminals=3” and “the positional information 3b to 3d” are obtained.

Next, the region control section 103a performs a state check process (step S1032). Specifically, the region control section 103a obtains, based on the positional information of the group generation terminal 1a, previous state information about groups having been previously generated in the vicinity of a position indicated by the positional information. The previous state information is typically information of the group which has been previously generated by the group generation terminal 1a on its own, and is the group user information stored in the group information storage section 11a. Other than this, the previous state information may be obtained from the group participation terminals 1b to 1d, or may be obtained from, for example, a server (not shown) which performs a collective management. When the previous state information represents a plurality of groups, the region control section 103a obtains an average A of the numbers (n(G1) to n(Gx)) of members that had participated in groups (G1 to Gx), respectively, according to the following equation [1].

A={n(G1)+n(G1)+ . . . +n(Gx)}/x [1]

Further, the region control section 103a checks a state at a position of the group generation terminal 1a, based on the positional information of the group generation terminal 1a. The state may be, for example, a congestion degree C. The congestion degree C. is an index indicating how many information communication terminals (users) are within a predetermined range. Specifically, the congestion degree C. is calculated, according to the following equations [2] and [3], by using the number N of the terminals, and the average A of the numbers of members of the previous groups. The closer a value of the congestion degree C. is to “1”, the more congested the region is.

C=1(A≦N) [2]

C=A/N(A>N) [3]

The region control section 103a sets a position, a shape, and a range of a group region for limiting information communication terminals that are allowed to participate in the group, based on the positional information, the number N of the information communication terminals located at current time, the average A of the numbers of members of the previous groups, and the congestion degree C. (step S1033). The position, the shape, and the range of the group region are set in, for example, the following manner.

FIG. 10 illustrates a region 5a1 which is set by using information of the positional information 3a by the region control section 103a, and a region 5a2 which is set in consideration of the congestion degree C. by the region control section 103a.

The region 5a1 represents a circle in which the center represents the coordinate (40, 40) of the group generation terminal 1a, which has been obtained by the positional information obtaining section 13a, and a radius represents a value obtained by a predetermined value containing the coordinate error “30”. The region control section 103a sets a group region in consideration of an error generated in the positional information obtaining section 13a of the group generation terminal 1a, to set a group region containing positions of all the users 2a to 2d as indicated by the region 5a1 in FIG. 10. Therefore, when all the users 2a to 2d request to participate in the group generated by the user 2a, the region 5a1 can be said to be appropriate.

However, a load on the group generation terminal 1a and a network may be increased depending on the number of users in the region 5a1. Therefore, in a case where the number of the information communication terminals 1 contained in the region 5a1 is excessively great, the size of the region 5a1 is favorably reduced, to restrict the number of the information communication terminals 1 contained in the region 5a1. The size of the region 5a1 is reduced by utilizing the congestion degree C. in the present invention. Specifically, when the congestion degree C. is small, the region is increased (the predetermined value is set to a high value), and when the congestion degree C. is great, the region is reduced (the predetermined value is set to a low value). In the example of FIG. 10, the region control section 103 changes the group region from the region 5a1 to the region 5a2 according to the congestion degree C.

It can be assumed that when the group generation terminal 1a sets the group region, another group may have been already generated in the vicinity. In this case, the group generation terminal 1a sets its group region, in consideration of the group region of the other group, as follows.

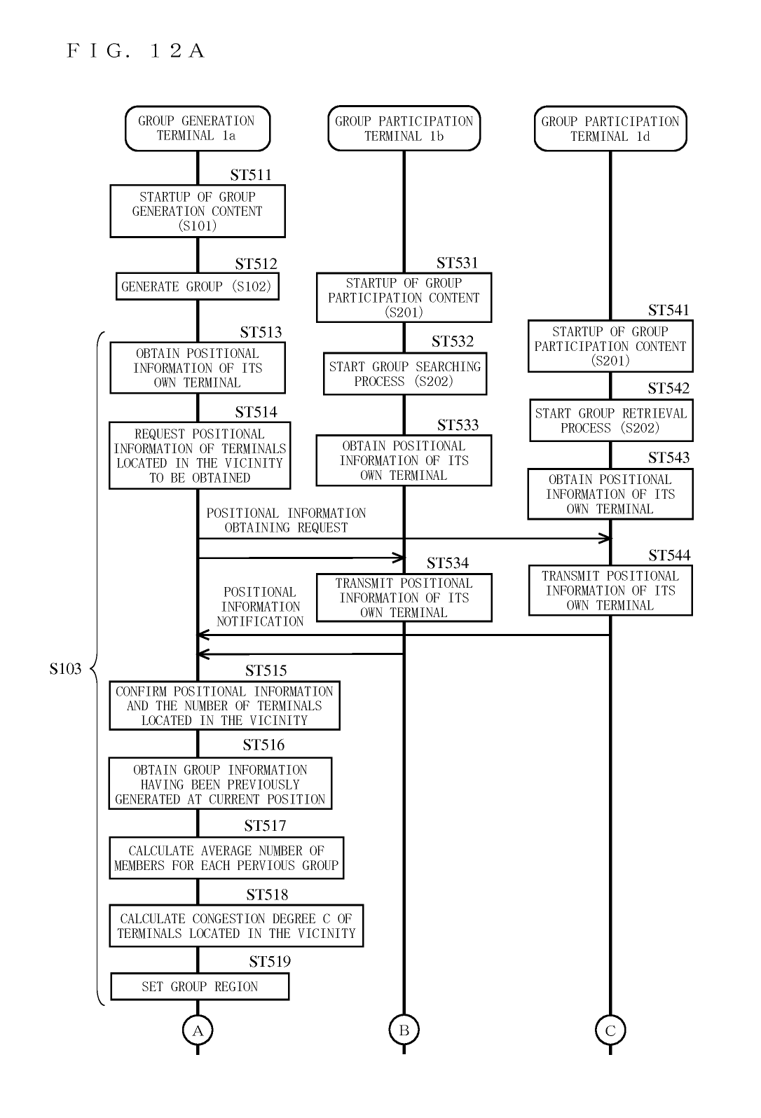

FIG. 11 illustrates an exemplary region setting method performed by the region control section 103a for preventing a plurality of group regions from overlapping each other. In this example, a case will be described in which, in a case where the group generation terminal 1c has already generated a region 5c1, the group generation terminal 1a generates a new group. The region 5c1 represents a circle in which the center represents the coordinate (60, 20) of the group generation terminal 1c which has been obtained by the positional information obtaining section 13c, and the radius is obtained so as to involve the coordinate error “20”.

As shown in FIG. 11, the region 5a1 which is a group region obtained as described above in no consideration of another group overlaps the region 5c1 having been already generated in a different region. In order to prevent a plurality of group regions from overlapping each other as described above, the region control section 103a of the group generation terminal 1a transmits a region overlapping confirmation request to the information communication terminals 1 located in the vicinity when setting the group region. The region overlapping confirmation request contains information about a position, a shape, and a range of a group region to be set by the terminal from which the request is transmitted.

The region control section 103c of the group generation terminal 1c determines, when receiving the region overlapping confirmation request from the group generation terminal 1a, whether or not the group region to be generated by the group generation terminal 1a overlaps the group region having been generated by its own terminal, and calculates group regions which do not cause the overlapping. The regions which do not cause the overlapping are, for example, a region 5c2 and a region 5a3 as shown in FIG. 11. These regions are calculated as follows.

Firstly, the region control section 103c sets a midpoint 61 between a center coordinate 3a2 of a group region to be generated by the group generation terminal 1a, and a center coordinate 3c2 of the group region having been already generated by the group generation terminal 1c, as a contact point between two group regions. The region control section 103c calculates a point 62 of intersection between a straight line E passing through the points 3a2, 61, and 3c2 and an outer edge of the region 5a1, and a point 63 of intersection between the straight line E and an outer edge of the region 5c1. Further, the region control section 103 calculates a midpoint 64 between the point 61 and the point 62, and a midpoint 65 between the point 61 and the point 63. Further, the region control section 103 calculates points 66 and 67 of intersection between the outer edge of the region 5a1, and a straight line F that is orthogonal to the straight line E and passes through the point 64, and calculates points 68 and 69 of intersection between the outer edge of the region 5c1, and a straight line G that is orthogonal to the straight line E and passes through the point 65. A region that passes through the points 61, 66, 62, and 67 as obtained by this calculation is represented as the region 5a3, and a region that passes through the points 61, 68, 63, and 69 is represented as the region 5c2. The region control section 103c of the group generation terminal 1c sets the group region of its own terminal as the region 5c2, and then issues a request for changing to the region 5a3, to the region control section 103a of the group generation terminal 1a having the overlapping group region.

The region control section 103a of the group generation terminal 1a which has received the region change request from the group generation terminal 1c, confirms that the region 5a3 indicated in the region change request causes no problem, and sets the group region of its own terminal as the region 5c3.

In the process steps as described above, also when a plurality of the information communication terminals 1 generate a plurality of groups at a similar time, the group regions can be set so as to prevent the overlapping. When the group regions are set in a state where a plurality of groups overlap each other, a priority is given over prevention of a plurality of group regions from overlapping each other without taking into consideration the congestion degree C.

### 3. PROCESS SEQUENCE EXECUTED AMONG A PLURALITY OF INFORMATION COMMUNICATION TERMINALS

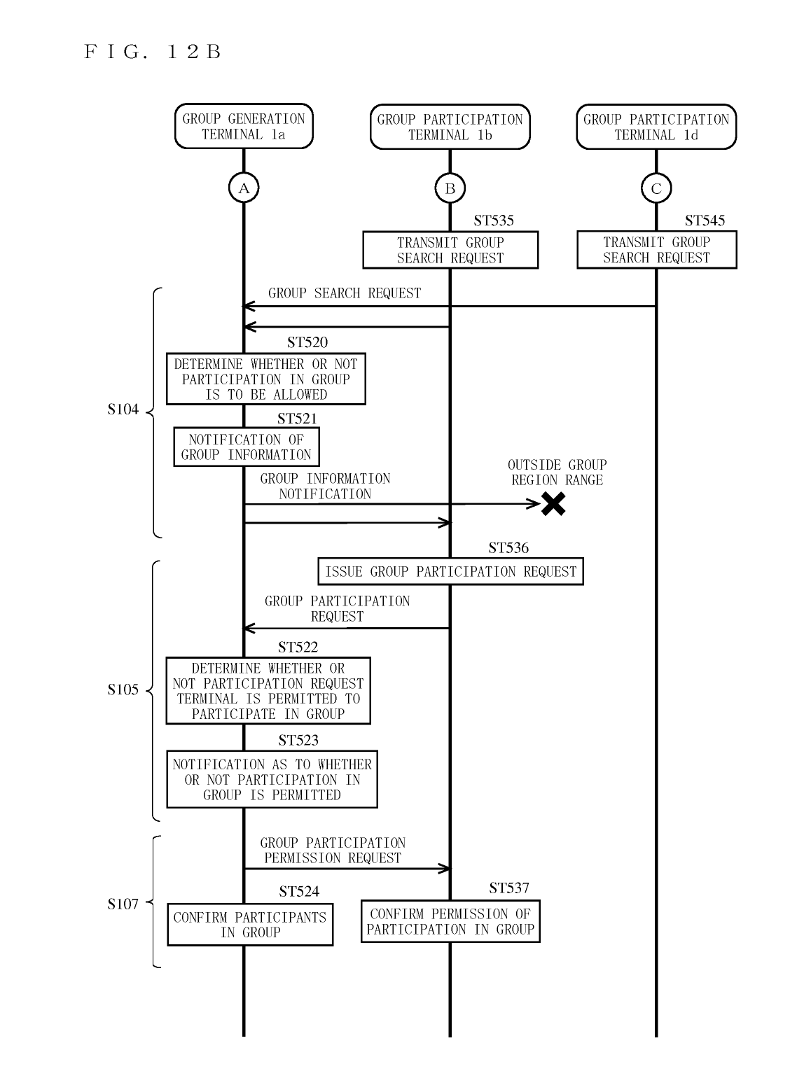

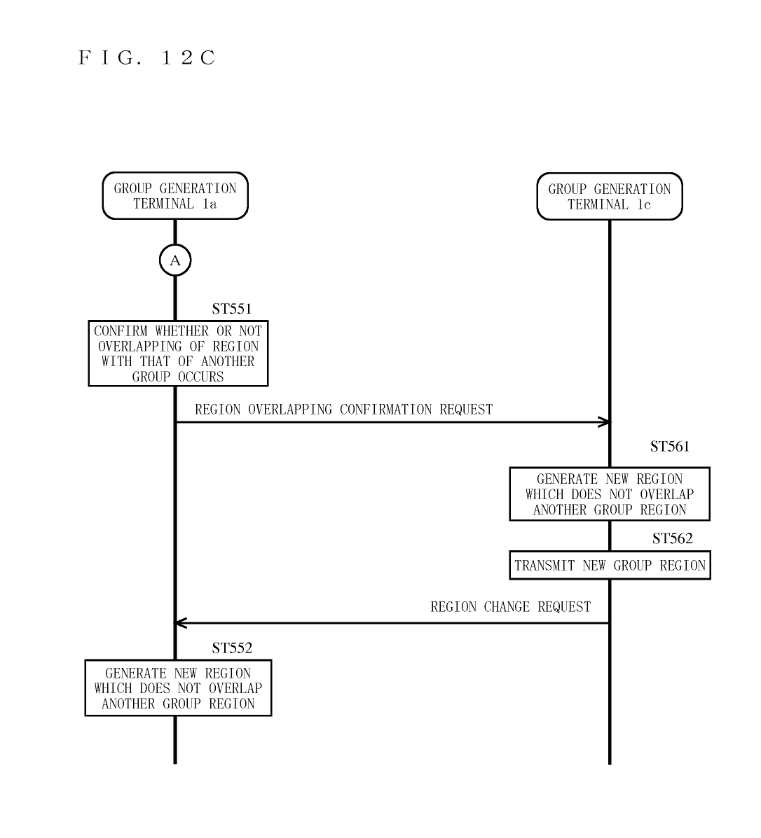

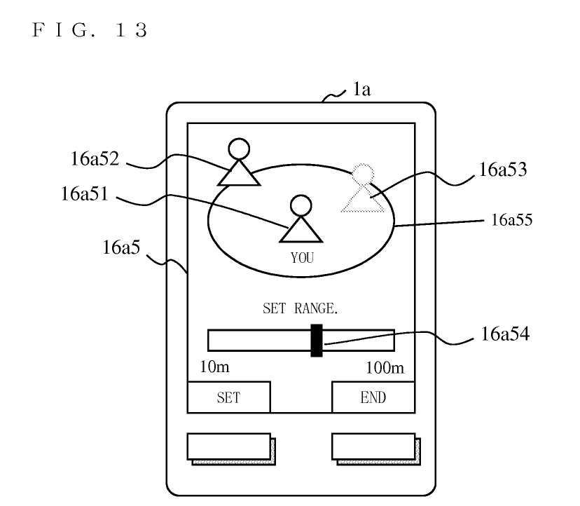

Next, the group generation process and the group participation process which are executed among a plurality of the information communication terminals 1 will be described in sequence with further reference to FIG. 12A to FIG. 12C.

In FIG. 12A and FIG. 12B, an exemplary case will be described in which, as described above, a series of process steps are performed among the group generation terminal 1a and the group participation terminals 1b and 1d, and only the group participation terminal 1b is allowed to participate in a group.

The group generation terminal 1a performs startup of the group generation content (ST511), obtains the user ID, the user name, the group ID, and the group name, and generates a group (ST512). Next, the group generation terminal 1a obtains its own positional information (ST513), and performs broadcast transmission of a request for obtaining the positional information of the group participation terminals 1b and 1d (ST514).

On the other hand, each of the group participation terminals 1b and 1d performs startup of the group participation content at an individual time (ST531, ST541), and starts to search for a group in which each of them can participate (ST532, ST542). After the process is started, the broadcast transmission of the group search request is performed at an optional time. Thereafter, each of the group participation terminals 1b and 1d obtains its own positional information (ST533, ST543), and notifies the group generation terminal 1a of the positional information, in response to the positional information obtaining request transmitted from the group generation terminal 1a (ST534, ST544).

The group generation terminal 1a confirms, when obtaining the positional information from each of the group participation terminals 1b and 1d, the positional information of the terminals located in the vicinity, and the number N thereof (ST515). The group generation terminal 1a obtains and calculates the previous group information, the average A of the numbers of the members of the previous groups, and the congestion degree C. (ST516 to 518), to set a group region (ST519). When the group region has been set, the group generation terminal 1a determines whether or not the group participation terminals 1b and 1d each of which has transmitted the group search request (ST535, ST545) are allowed to participate in the generated group (ST520). According to a result of the determination, the group generation terminal 1a makes a notification of the group information, only to the group participation terminal 1b which is allowed to participate in the generated group (ST521).

In a case where the group participation terminal 1b having received the group information notification participates in the group, the group participation terminal 1b transmits the group participation request to the group generation terminal 1a (ST536).

The group generation terminal 1a determines, when receiving the group participation request from the group participation terminal 1b, whether or not the group participation terminal 1b may be permitted to participate in the group (ST522), and transmits the group participation permission notification to the group participation terminal 1b in the case of the participation being permitted (ST523).

Thereafter, the group generation terminal 1a confirms the group, and ends the group generation process (ST524).

Further, the group participation terminal 1b confirms that participation in the group has been permitted, based on the group participation permission notification received from the group generation terminal 1a, and thereafter ends the group participation process (ST537).

In FIG. 12C, a process for preventing a plurality of group regions from overlapping each other in the region setting process will be described. The overlapping prevention process shown in FIG. 12C is performed each time a group region is generated by any one of the group generation terminals 1.

When the group region is set (FIG. 12A, ST519), the group generation terminal 1a performs broadcast transmission of a region overlapping confirmation request to the terminals located in the vicinity (ST551). The group generation terminal 1c having already generated a group newly generates two appropriate group regions so as to prevent a state in which the group region generated by the group generation terminal 1c and the group region generated by the group generation terminal 1a overlap each other (ST561). The group generation terminal 1c sets, as its own group region, one of the group regions having been newly generated, and requests the group generation terminal 1a to change the group region having been set, to the other of the group regions having been newly generated (ST562).

The group generation terminal 1a confirms, when receiving the region change request from the group generation terminal 1c, the other of the group regions indicated in the region change request, and changes the group region having been temporarily set, to the other of the group regions (ST552).

### 4. OTHER EXAMPLES

FIG. 13 illustrates an exemplary user interface for allowing a shape and a range of a group region to be set with a simple user operation.

FIG. 13 illustrates a display screen 16a5 displayed on the display section 16a of the group generation terminal 1a, and illustrates a position 16a51 of its own terminal, and approximate positions 16a52 and 16a53 of the information communication terminals 1 located in the vicinity thereof. On the display screen 16a5 shown in FIG. 13, a range of a region 16a55 can be changed by moving leftward and rightward an input tab 16a54 that is integrated with a touch panel. FIG. 13 illustrates an exemplary case in which the radius is 10 m when the input tab 16a54 has been moved to the leftmost end, and the radius is 100 m when the input tab 16a54 has been moved to the rightmost end.

In such a procedure, a user can easily set an appropriate region, according to the number of members in a group as intended by the user. When the region is set by such a user operation, shading for display may be changed according to the coordinate error, as indicated for a position 16a53 of the information communication terminal 1 (the greater the coordinate error is, the lighter the display is). In this manner, in a case where an accuracy of a position of a user as is displayed on the screen, is low, the display becomes light. Therefore, the group generator can set the range of the region in consideration of a measurement error of a GPS.

As described above, the group generation device 10 according to one embodiment of the present invention sets a region within which requests for participation in a group are accepted, based on a current and a previous states at a position at which a terminal that generates the group is located. Therefore, even if the vicinity of the terminal is heavily congested, subjects that are allowed to participate in a group can be appropriately controlled. Thus, both the group generator and group participant can form a desired group (community) without performing a complicated procedure as in the conventional arts.

In the above embodiment, an exemplary case is described in which the group generation device 10 is included in the information communication terminal 1. However, the group generation device 10 may be included in a server. In this case, the process steps of step S102 to step S107 shown in FIG. 4 are executed by the server. Further, the process is performed such that the group generation terminal 1a issues a group generation request to the server, and receives the group information generated by the server in step S107.

Further, a part or the entirety of the functional blocks of the group generation device according to the embodiment of the present invention is implemented by using hardware resources such as a central processing unit (CPU), a storage device (memory (ROM, RAM, or the like), hard disk, or the like), and an input/output device, and is typically implemented as an IC (also referred to as an LSI, a system LSI, a super LSI, an ultra LSI, or the like), which is an integrated circuit. These functional blocks may be each made into one chip individually, or a part or the entirety thereof may be made into one chip.

In addition, a technique of integrated circuit implementation is not limited to the IC, but may be implemented by a dedicated circuit or a general-purpose processor. Further, an FPGA (Field Programmable Gate Array) which is programmable after production of an IC, and a reconfigurable processor that enables the connection and the settings of circuit cells in the IC to be reconfigured, may be used.

Further, needless to say, if a technique (biotechnology or the like) of integrated circuit implementation, which replaces an IC, becomes available due to improvement of semiconductor technology or due to emergence of another technique derived therefrom, integration of the functional blocks may be performed by using the technique.

Further, the group generation method executed by the group generation device according to the embodiment of the present invention as described above, may be implemented by the CPU interpreting and executing predetermined program data that allows the procedure of the group generation method, which is stored in a storage device, to be executed. In this case, the program data may be loaded into the storage device via a storage medium such as a CD-ROM, a flexible desk, or the like, or may be executed directly on the storage medium. Here, examples of the storage medium include: a semiconductor memory such as a ROM, a RAM, and a flash memory; a magnetic disk memory such as a flexible disk and a hard disk; an optical disk memory such as a CD-ROM, a DVD, and a BD; and a memory card. Further, the storage medium has a concept including a communication medium such as a telephone line, a transmission path, and the like.

### INDUSTRIAL APPLICABILITY

The group generation device of the present invention can be mounted to portable information communication terminals such as mobile telephones, smartphones, portable music players, hand-held game devices, and PDAs, and is particularly useful in, for example, a case where a desired group (community) is to be formed without causing a plurality of users to perform complicated procedures.

### DESCRIPTION OF THE REFERENCE CHARACTERS

1, 1a, 1b, 1c, 1d information communication terminal
2a, 2b, 2c, 2d user
10 group generation device
11 group information storage section
12 user information storage section
13 positional information obtaining section
14 communication section
15, 15a1, 15a2, 15b1, 15b2 user input section
16,
17 contents section
101 reception section
102 generation section
103 region control section
104 determination section
16a1 to 16a5, 16b1 to 16b4 display screen

1. A group generation device for generating a group to be formed by a plurality of information communication terminals located at predetermined positions, the group generation device comprising:
a reception section configured to receive a group generation request transmitted from an information communication terminal which generates a group, and a group participation request transmitted from an information communication terminal which participates in a group;
a generation section configured to generate a group of which a master information communication terminal having transmitted the group generation request is representative;
a region control section configured to check a state at a position at which the master information communication terminal is located, by utilizing positional information of the master information communication terminal, and set, based on the state, a group region of the group generated by the generation section; and
a determination section configured to determine, by utilizing positional information of a subordinate information communication terminal having transmitted the group participation request, whether or not the subordinate information communication terminal is within the group region, wherein
the determination section permits the subordinate information communication terminal which is determined to be within the group region to participate in the group.

2. The group generation device according to claim 1, wherein the region control section checks a congestion state at a position at which the master information communication terminal is located, based on the number of the subordinate information communication terminals located within a predetermined range from the position of the master information communication terminal, and when the predetermined range is congested, the group region is reduced.

3. The group generation device according to claim 2, wherein the region control section checks the congestion state by using information about groups previously generated in the vicinity of the position at which the master information communication terminal is located.

4. The group generation device according to claim 1, wherein the region control section obtains the positional information of the master information communication terminal and error information for a position indicated by the positional information, and sets the group region by using the positional information and the error information having been obtained.

5. The group generation device according to claim 4, wherein the region control section further obtains the positional information of the subordinate information communication terminal located within a predetermined range from the position of the master information communication terminal, and error information for a position indicated by the positional information, and sets the group region by using the positional information and the error information having been obtained.

6. The group generation device according to claim 4, wherein the region control section checks whether or not the group region for the master information communication terminal overlaps another group region generated by another master information communication terminal which is located within a predetermined range from the position of the master information communication terminal, and sets a region which does not overlap the other group region, as the group region generated by the generation section.

7. The group generation device according to claim 4, wherein the region control section checks whether or not the group region for the master information communication terminal overlaps another group region generated by another master information communication terminal which is located within a predetermined range from the position of the master information communication terminal, and requests, when the group region generated by the generation section overlaps the other group region, the other master information communication terminal to change the other group region.

8. A group generation method, executed by an information communication terminal, for generating a group to be formed by a plurality of information communication terminals located at predetermined positions, the group generation method comprising the steps of:
receiving a group generation request transmitted from an information communication terminal which generates a group, and a group participation request transmitted from an information communication terminal which participates in a group;
generating a group of which a master information communication terminal having transmitted the group generation request is representative;
checking a state at a position at which the master information communication terminal is located, by utilizing positional information of the master information communication terminal, and setting, based on the state, a group region of the group generated by the generation section;
determining, by utilizing positional information of a subordinate information communication terminal having transmitted the group participation request, whether or not the subordinate information communication terminal is within the group region;
permitting the subordinate information communication terminal which is determined to be within the group region to participate in the group.

9. A computer-readable program for causing an information communication terminal to execute a group generation method for generating a group to be formed by a plurality of information communication terminals located at predetermined positions, the program comprising the steps of:
receiving a group generation request transmitted from an information communication terminal which generates a group, and a group participation request transmitted from an information communication terminal which participates in a group;
generating a group of which a master information communication terminal having transmitted the group generation request is representative;
checking a state at a position at which the master information communication terminal is located, by utilizing positional information of the master information communication terminal, and setting, based on the state, a group region of the group generated by the generation section;
determining, by utilizing positional information of a subordinate information communication terminal having transmitted the group participation request, whether or not the subordinate information communication terminal is within the group region;
permitting the subordinate information communication terminal which is determined to be within the group region to participate in the group.

10. An integrated circuit for use in a group generation device for generating a group to be formed by a plurality of information communication terminals located at predetermined positions, the integrated circuit having integrated therein circuits functioning as:
a reception section configured to receive a group generation request transmitted from an information communication terminal which generates a group, and a group participation request transmitted from an information communication terminal which participates in a group;
a generation section configured to generate a group of which a master information communication terminal having transmitted the group generation request is representative;
a region control section configured to check a state at a position at which the master information communication terminal is located, by utilizing positional information of the master information communication terminal, and sets, based on the state, a group region of the group generated by the generation section; and
a determination section configured to determine, by utilizing positional information of a subordinate information communication terminal having transmitted the group participation request, whether or not the subordinate information communication terminal is within the group region, and permit the subordinate information communication terminal which is determined to be within the group region to participate in the group.
